(19) United States
(12) Patent Application Publication
(10) Pub. No.: US 2007/0230485 A1
(43) Pub. Date: Oct. 4, 2007

(54) Service providing method, computer-readable recording medium containing service providing program, and service providing apparatus

(75) Inventors: Yuji Wada, Kawasaki (JP); Takao Mohri, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/489,355

(22) Filed: Jul. 19, 2006

(30) Foreign Application Priority Data
Mar. 30, 2006 (JP) 2006-095623

(51) Int. Cl. H04L 12/56

(52) U.S. Cl. 370/401; 370/252

(57) ABSTRACT

A service providing method for allowing a user to select services matching his/her tastes with less personal data. When a service request arrives, a service category presenter extracts and transmits a plurality of service category information from a service category storage unit to a terminal device. When the identification information of selected service category information arrives from the terminal device via a network, a service specifying unit specifies the services associated with the selected service category information by referring to the metadata storage unit. A service providing unit extracts and transmits service data on the specified services from a service data storage unit to the terminal device.

### CROSS-REFERENCE TO RELATED APPLICATIONS

This application is based upon and claims the benefits of priority from the prior Japanese Patent Application No. 2006-095623, filed on Mar. 30, 2006, the entire contents of which are incorporated herein by reference.

### BACKGROUND OF THE INVENTION

(1) Field of the Invention

This invention relates to a service providing method, a computer-readable recording medium containing a service providing program, and a service providing apparatus, for providing services to terminal devices. More particularly, this invention relates to a service providing method, a computer-readable recording medium containing a service providing program, and a service providing apparatus, for narrowing a large number of services down according to user demand and providing appropriate services.

(2) Description of the Related Art

At present, a large amount of content is provided via various kinds of means including the Internet and television broadcasting. Users select and view content of interest. However, it is hard to find appropriate content out of the large amount of content. Therefore, a technique of automatically selecting user's favorite content has been offered (refer to Japanese Unexampled Patent Publication No. 2004-357334).

On the other hand, a server may be designed to be capable of selecting content matching user tastes. For example, a user accesses the server from his/her terminal device and enters personal data including interests. Then the server searches a large amount of content for content appropriate for the entered personal data. Then the server transmits the found content to the user terminal device.

However, if the user wants to use services appropriate for his/her situation, tastes and authority with his/her terminal device, information that the user allows to be provided to a service provider may be insufficient for the service provider. That is to say, the user is unwilling to enter much information, which is required for narrowing services down, because it is a bothering work. In addition, to avoid leakage of personal data, the user wants to disclose the personal data as less as possible. The service provider, on the other hand, wants to know all kinds of information on the user to provide better services. To ameliorate this conflict, only appropriate services should be simply provided by disclosing less personal data.

### SUMMARY OF THE INVENTION

This invention has been made in view of foregoing and intends to provide a service providing method, a computer-readable recording medium containing a service providing program, and a service providing apparatus, which enable selecting services matching user tastes with less personal data.

To accomplish the above problem, there is provided a service providing method for providing services via a network. In the service providing method, a service category presenter, when receiving a service request from a terminal device connected over the network, extracts and transmits a plurality of service category information from service category storage unit to the terminal device, the service category storage unit storing the service category information indicating the features of groups into which available services are classified; a service specifying unit, when receiving the identification information of selected service category information from the terminal device, specifies services associated with the selected service category information by referring to a metadata storage unit storing service category metadata of the services associated with each of the service category information stored in the service category storage unit; and a service providing unit extracts and transmits service data on the specified services from a service data storage unit to the terminal device, the service data storage unit storing the service data necessary for provision of the services.

Further, to accomplish the above object, there is provided a computer-readable recording medium containing a service providing program for providing services via a network. The service providing program contained in the recording medium causes a computer to perform as: a service category storage unit for storing service category information indicating the features of groups into which available services are classified; a metadata storage unit for storing the service category metadata of services associated with each of the service category information stored in the service category storage unit; a service data storage unit for storing service data necessary for provision of each service; a service category presenter for, when receiving a service request from a terminal device connected over the network, extracting and transmitting a plurality of service category information from the service category storage unit to the terminal device; a service specifying unit for, when receiving the identification information of selected service category information from the terminal device, specifying the services associated with the selected service category information by referring to the metadata storage unit; and a service providing unit for extracting and transmitting the service data on the specified services from the service data storage unit to the terminal device.

Still further, to accomplish the above problem, there is provided a service providing apparatus for providing services via a network. The service providing apparatus comprises: a service category storage unit for storing service category information indicating the features of groups into which available services are classified; a metadata storage unit for storing the service category metadata of services associated with each of the service category information stored in the service category storage unit; a service data storage unit for storing service data necessary for provision of each service; a service category presenter for, when receiving a service request from a terminal device connected over the network, extracting and transmitting a plurality of service category information from the service category storage unit to the terminal device; a service specifying unit for, when receiving the identification information of selected service category information from the terminal device, specifying services associated with the selected service category information by referring to the metadata storage unit; and a service providing unit for extracting and transmitting the service data on the specified services from the service data storage unit to the terminal device.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 shows an outline of one embodiment.

FIG. 2 is a conceptual view showing connections between user personal data and services via service categories.

FIG. 3 shows an example of narrowing services down by using service category information.

FIG. 4 shows a system configuration of the embodiment.

FIG. 5 is a conceptual view showing how services are provided.

FIG. 6 shows a hardware configuration of a portal site server to be used in this embodiment.

FIG. 7 is a functional block diagram of each device.

FIG. 8 shows profile data to be stored in a profile storage unit.

FIG. 9 shows an example of personality data to be stored in a personality data storage unit.

FIG. 10 shows an example of service data to be stored in a service data storage unit.

FIG. 11 shows an example of service information to be stored in a service information storage unit.

FIG. 12 shows an example of service category information to be stored in a service category storage unit.

FIG. 13 shows an example of service category metadata to be stored in a metadata storage unit.

FIG. 14 shows an example of service category hierarchical information to be stored in a hierarchical information storage unit.

FIG. 15 is a sequence diagram showing processes to be performed between a terminal device and a portal site server.

FIG. 16 is a flowchart showing how to limit service category information.

FIG. 17 shows an example of how to limit and provide service data based on a purpose of use.

FIG. 18 shows a first example of how to provide service data according to user-selected personality data.

FIG. 19 shows a second example of how to provide service data according to user-selected personality data.

### DESCRIPTION OF THE PREFERRED EMBODIMENTS

Preferred embodiments of this invention will be described with reference to the accompanying drawings.

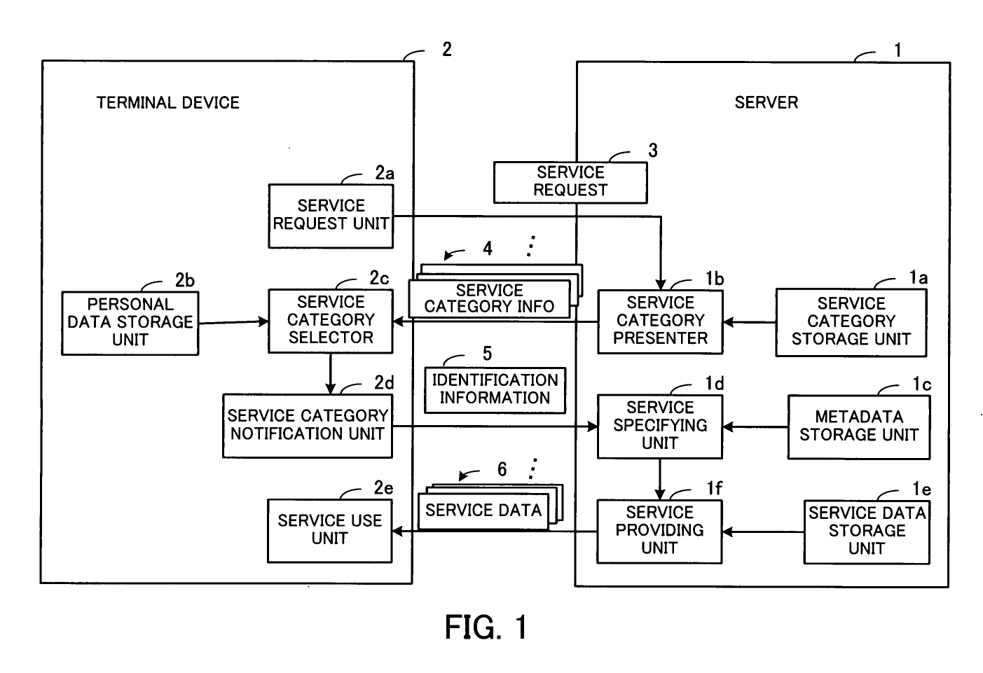

FIG. 1 shows an outline of this embodiment. In the embodiment, a server 1 provides services to a terminal device 2. To do so, the server 1 has a service category storage unit 1a, a service category presenter 1b, a metadata storage unit 1c, a service specifying unit 1d, a service data storage unit 1e, and a service providing unit 1f.

The service category storage unit 1a stores service category information indicating the features of groups into which available services are classified.

The service category presenter 1b extracts a plurality of service category information from the service category storage unit 1a when receiving a service request 3 from the terminal device 2 connected over a network. Then the service category presenter 1b transmits the extracted service category information 4 to the terminal device 2.

The metadata storage unit 1c stores the service category metadata of services that are associated with each of the service category information stored in the service category storage unit 1a.

Upon reception of the identification information 5 of selected service category information from the terminal device 2 via the network, the service specifying unit 1d specifies the services associated with the selected service category information by referring to the metadata storage unit 1c.

The service data storage unit 1e stores service data to be used for service provision.

The service providing unit if extracts the service data of the services specified by the service specifying unit 1d, from the service data storage unit 1e. Then the service providing unit if transmits the extracted service data 6 to the terminal device 2.

The terminal device 2 has a service request unit 2a, personal data storage unit 2b, a service category selector 2c, a service category notification unit 2d, and a service use unit 2e.

The service request unit 2a transmits a service request 3 to the server 1 in response to a command entered by a user of the terminal device 2.

The personal data storage unit 2b stores the personal data on the user of the terminal device 2. For example, the personal data includes age, sex, and interests.

The service category selector 2c receives a plurality of service category information 4 from the server 1. Then the service category selector 2c selects, out of the plurality of service category information 4, service category information that indicates characteristics matching the personal data stored in the personal data storage unit 2b.

The service category notification unit 2d transmits to the server 1 the identification information 5 of the service category information selected by the service category selector 2c.

The service use unit 2e receives a plurality of service data 6 from the server 1. Then the service use unit 2e receives provision of services based on service data selected out of the plurality of service data 6 according to user operation.

With such a system, when a user enters a service request to the terminal device 2, the service request unit 2a of the terminal device 2 transmits a service request 3 to the server 1. When the server 1 receives the service request 3 from the terminal device 2, the service category presenter 1b extracts a plurality of service category information from the service category storage unit 1a. Then the service category presenter 1b transmits the plurality of service category information 4 to the terminal device 2.

The plurality of service category information 4 is received by the service category selector 2c of the terminal device 2. The service category selector 2c then selects service category information that indicates characteristics matching the personal data stored in the personal data storage unit 2b, from the plurality of service category information 4. Then the service category notification unit 2d transmits the identification information 5 of the service category information selected by the service category selector 2c to the server 1.

In the server 1, the service specifying unit 1d receives the identification information 5 from the terminal device 2. The service specifying unit 1d then specifies the services associated with the service category information selected by the terminal device 2 based on the service category metadata stored in the metadata storage unit 1c. Then the service providing unit if extracts the service data 6 of the specified services from the service data storage unit 1e, and transmits the extracted service data 6 to the terminal device 2.

In the terminal device 2, the service use unit 2e receives the plurality of service data 6. The service use unit 2e then uses services based on user-requested service data 6.

As described above, the terminal device 2 can receive the service data 6 appropriate for user personal data without disclosing the personal data to the server 1. In addition, the user can easily select services of interest from a large number of services.

Further, the terminal device 2 checks connections between user personal data and service category information, out of connections between the personal data and services via the service category information, so that the personal data may not be disclosed to the server 1.

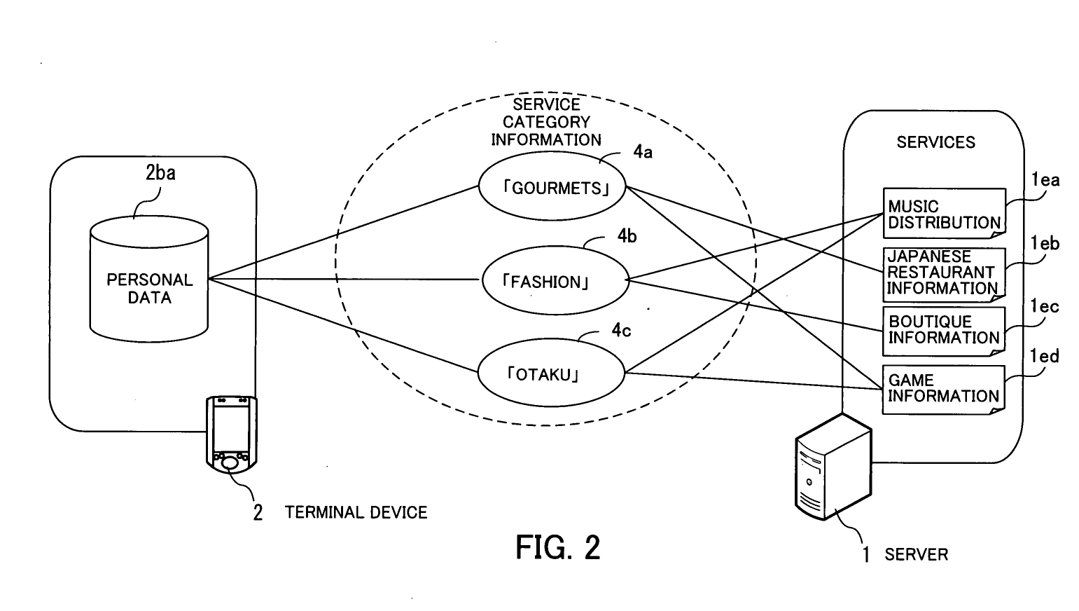

FIG. 2 is a conceptual view showing connections between personal data and services via service category information. As shown in FIG. 2, the server 1 provides the terminal device 2 with service category information 4a, 4b, and 4c. The terminal device 2 selects service category information appropriate for personal data 2ba, and then notifies the service 1 of the selected service category information.

The server 1, on the other hand, manages services 1ea, 1eb, 1ec, and 1ed belonging to the service category information groups 4a, 4b, and 4c, and is designed to provide the services belonging to a selected service category information group to the terminal device 2.

The services 1ea, 1eb, 1ec, and led can belong to a plurality of service category information groups. In this example of FIG. 2, music distribution service 1ea belongs to both the service category information “fashion” 4b and the service category information “otaku (this is a Japanese term to indicate people who have acquainted with a specific field, especially anime or computer)” 4c.

Personal data is not necessarily of the user himself/herself. Virtual personal data can be created for using different kinds of services. Purposes for using services can be used for narrowing services down.

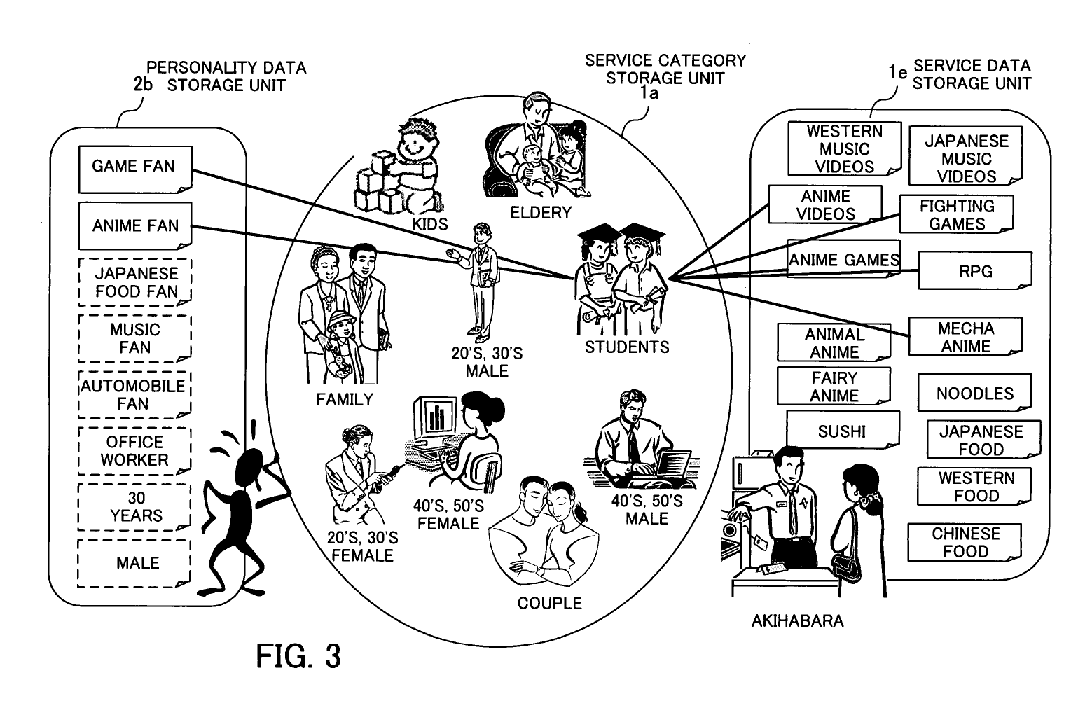

FIG. 3 shows an example of narrowing services down by using service category information. As shown in FIG. 3, the personal data storage unit 2b stores personal data such as “game fan” and “anime fan”. In addition, the service category storage unit 1a stores various kinds of service category information such as “students” and “family”. The service data storage unit 1e stores service data such as “Western music videos” and “Japanese music videos”.

It is now assumed that the user would like to know about information on games and anime in Akihabara (which is a place where there are lots of anime and computer shops that otaku people like). The user transmits a service request specifying “Akihabara” as a place to the server 1. The server 1 provides the terminal device 2 with only service category information containing services relating to “Akihabara”.

In the terminal device 2, only “game fan” and “anime fan” are set as personal data. Even the user has other kinds of personal data such as “office worker”, “thirty years”, and “male”, the data can be made invalid in the personal data storage unit 2b (the invalid personal data is indicated by doted line in this figure). Therefore, the terminal device 2 selects service category information of “students” based on the personal data of “game fan” and “anime fan”. That is, for the user who is an office worker of thirty years, the terminal device 2 selects the service category information of “students”. Then the server 1 provides service data for providing information on “anime videos”, “fighting games”, and so on belonging to the service category information.

Since the user can set virtual personalities as personal data, he/she can have some kinds of personal data indicating different personalities as personality data. When the user wants to use services, the user can select desired personality data depending on purposes of using the services. Now, this embodiment will be described in detail in view of a system example where the user can use services by creatively using a plurality of personality data.

A following embodiment includes a function to narrow services down based on conditions for use in addition to fixed personal data such as user situation (place and purposes). This case also realizes narrowing the services down with less personal data disclosed.

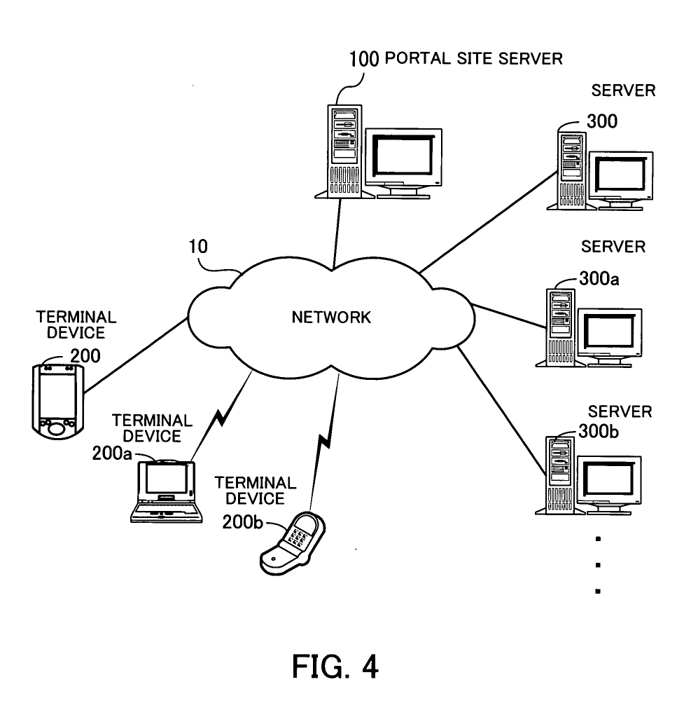

FIG. 4 shows a system configuration of this embodiment. In this embodiment, a portal site server 100, a plurality of servers 300, 300a, 300b, . . . , and a plurality of terminal devices 200, 200a, 200b, . . . are connected to each other over a network 10.

The servers 300, 300a, 300b, . . . , provide information services such as content, application programs, etc., to the terminal devices 200, 200a, 200b, . . . over the network 10. The portal site server 100 provides the terminal devices 200, 200a, 200b, . . . with information on the services to be provided by the servers 300, 300a, 300b . . . The terminal devices 200, 200a, 200b, . . . are portable terminal devices or mobile computers which users have. The users can use the services provided by the servers 300, 300a, 300b, . . . by using the terminal devices 200, 200a, 200b, . . . .

In such a system, the user accesses the portal site server 100 from the terminal device 200 to obtain a list of services appropriate for his/her personal data from the portal site server 100. By selecting a desired service with the terminal device 200, the user can use the service provided by the server.

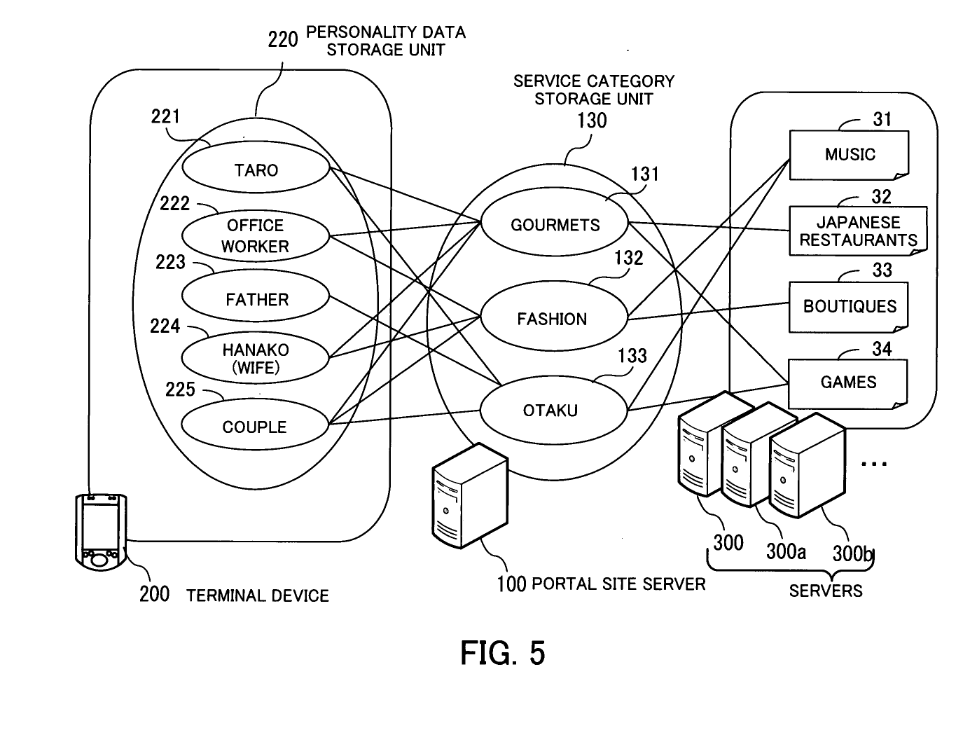

FIG. 5 is a conceptual view showing how services are provided. In this example of FIG. 5, it is assumed that a user uses the terminal device 200. In the following explanation, this embodiment will be described in detail in view of an example where the terminal device 200 is used to receive service provision.

The terminal device 200 has a personality data storage unit 220. The personality data storage unit 220 stores personality data 221 to 225 indicating virtual personalities created by the user.

For example, the personality data 221 is personal data on the user himself, and indicates user's age, sex, and so on. The personality data 222 describes the personality of an office worker who is imagined by the user. For example, the personality data 222 includes places close to the office as hangouts. The personality data 223 and 224 are personal data on user's father and wife, respectively. The personality data 225 describes information on a couple of the user and his wife.

The portal site server 100 has a service category storage unit 130. The service category storage unit 130 stores a plurality of service category information 131 to 133. Each of the service category information 131 to 133 is associated with a plurality of services and has criterion (for example, age group) so as to specify target users.

For example, the service category information 131 indicates the characteristics of gourmets. The service category information 132 indicates the characteristics of people who care for fashion. The service category information 133 indicates the characteristics of otaku people.

In this example of FIG. 5, each of the service category information 131 to 133 is linked to personality data matching the characteristics set in the service category information. In addition, each of the service category information 131 to 133 is linked to services to be provided as the services associated with the service category information 131 to 133.

The plurality of servers 300, 300a, 300b, . . . have services 31 to 34 that can be provided to users. For example, the service 31 is a music distribution service for distributing music data. The service 32 is a service for providing information on Japanese restaurants. The service 33 is a service for providing information on boutiques. The service 34 is a service for providing connection environments for online games.

To search for a desired service, the user selects appropriate personality data out of the previously registered personality data 221 to 225 with the terminal device 200. Then the terminal device 200 obtains service category information 131 to 133 from the portal site server 100, and selects service category information matching the user-selected personality data. If the user selects the personality data 221, the service category information “gourmets” 131 and the service category information “otaku” 133 are selected.

The terminal device 200 notifies the portal site server 100 of the selected service category information. The portal site server 100 narrows the services 31 to 34 down to the services associated with the selected service category information. Then the portal site server 100 creates information (for example, access destinations providing the services) on the detected services, and gives this information to the terminal device 200.

The user selects a desired service from the information on the services obtained from the portal site server 100. Then the terminal device 200 accesses the server providing the selected service, so that the user can use the service of the server.

A system configuration for providing services as shown in FIG. 5 will be now described.

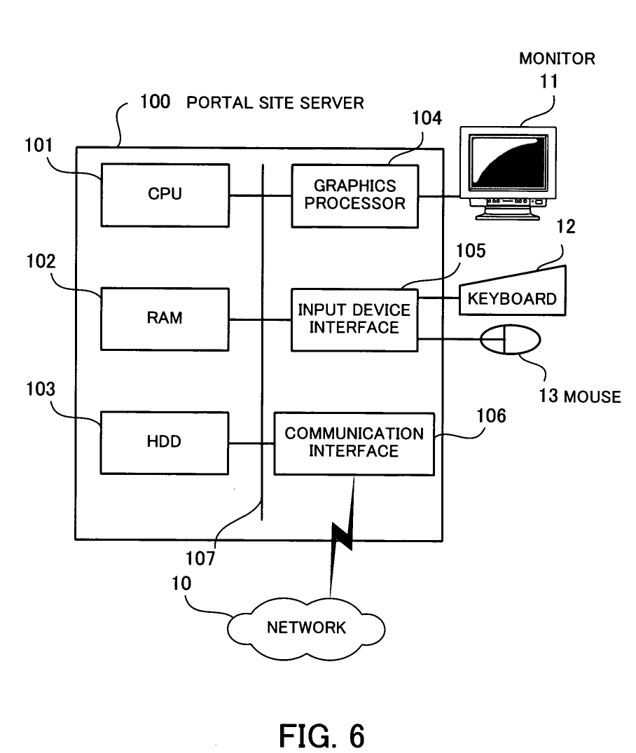

FIG. 6 shows an example hardware configuration of a portal site server that is used in this embodiment. The portal site server 100 is entirely controlled by a Central Processing Unit (CPU) 101. Connected to the CPU 101 via a bus 107 are a Random Access Memory (RAM) 102, a Hard Disk Drive (HDD) 103, a graphics processor 104, an input device interface 105, and a communication interface 106.

The RAM 102 temporarily stores at least part of an Operating System (OS) program and application programs to be executed by the CPU 101. The RAM 102 also stores various data for CPU processing. The HDD 103 stores the OS program and the application programs.

The graphics processor 104 is connected to a monitor 11 to display images on the monitor 11 under the control of the CPU 101. The input device interface 105 is connected to a keyboard 12 and a mouse 13 and is designed to transfer signals from the keyboard 12 and the mouse 13 to the CPU 101 via the bus 107.

The communication interface 106 is connected to the network 10. The communication interface 106 communicates data with other computers over the network 10

Such the hardware configuration realizes the processing functions of this embodiment. Although FIG. 6 shows the hardware configuration of the portal site server 100, the other servers 300, 300a, 300b . . . and terminal devices 200, 200a, 200b, . . . may have the same hardware configuration.

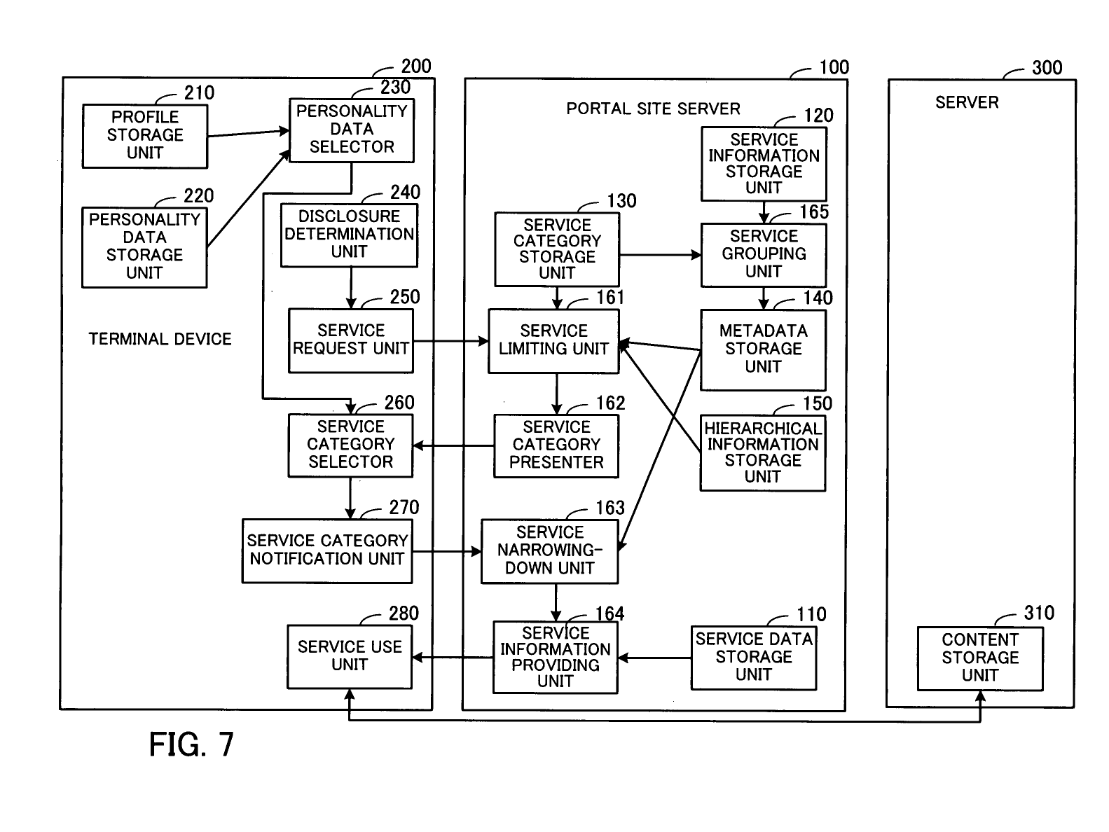

FIG. 7 is a functional block diagram of each device. The terminal device 200 has a profile storage unit 210, a personality data storage unit 220, a personality data selector 230, a disclosure determination unit 240, a service request unit 250, a service category selector 260, a service category notification unit 270, and a service use unit 280. The functions of the personality data storage unit 220 were described above with reference to FIG. 5.

The profile storage unit 210 stores profile data expressing user personal data. The profile data contains user age, sex, and so on.

The personality data selector 230 selects at least one piece of personality data from the personality data storage unit 220 according to user operation. The personality data storage unit 220 gives the selected personality data to the service category selector 260.

The disclosure determination unit 240 determines which information is to be disclosed, other than personality data, as information to be used for narrowing services down, according to user operation. The information to be disclosed is positional information indicating a user's current position, a purpose for using services, or the like. The disclosure determination unit 240 gives disclosure information to the service request unit 250.

The service request unit 250 issues a service request to the portal site server 100. At this time, the service request unit 250 transmits terminal information on the hardware conditions of the terminal device 200 (for example, terminal type or free memory capacity) and disclosure information (position or purpose), together with the service request to the portal site server 100.

The service category selector 260 obtains a set of service category information from the portal site server 100. Then the service category selector 260 selects service category information matching the user-selected personality data out of the set of the service category information. Then the service category selector 260 gives the selected service category information to the service category notification unit 270.

The service category notification unit 270 transmits the identification information of the selected service category information to the portal site server 100.

The service use unit 280 receives a list of services from the portal site server 100. The service use unit 280 accesses the server 300 providing a service selected according to user operation to receive the service provision.

The portal site server 100 has a service data storage unit 110, a service information storage unit 120, a service category storage unit 130, a metadata storage unit 140, a hierarchical information storage unit 150, a service limiting unit 161, a service category presenter 162, a service narrowing-down unit 163, a service information providing unit 164, and a service grouping unit 165.

The service data storage unit 110 stores service content, programs, and Uniform Resource Locators (URLs) of content provided by servers.

The service information storage unit 120 stores service information about available services. The service information is metadata that describes the features of each service.

The service category storage unit 130 stores service category information. The service category information includes the identification information of a service category, and information (represented in evaluation formula) indicating the features of the services belonging to the service category group.

The metadata storage unit 140 stores service category metadata of service categories. The service category metadata contains information on services associated with a corresponding service category.

The hierarchical information storage unit 150 stores service category hierarchical information. The service category hierarchical information contains parental relations for hierarchically managing a plurality of service categories. Parent service category information contains the services included in child service category information.

The service limiting unit 161 extracts service categories having an appropriate degree of details to provide, based on terminal information received from the terminal device 200. Specifically, the service limiting unit 161 sequentially limits services in depth until service category information can be stored on a memory of the terminal device 200. That is to say, service category information to be provided is changed from all of a plurality of service category information in a hierarchical structure (data volume becomes small as a level in the hierarchical structure is lower) to service category information of lower level so that the lower-level service category information can be stored on the memory of the terminal device 200. The service limiting unit 161 gives the suitable-level service category information to the service category presenter 162.

The service category presenter 162 transmits a set of suitable-level service category information to the terminal device 200.

The service narrowing-down unit 163 narrows services down to provide a user, based on the identification information of service category information received from the terminal device 200. The service narrowing-down unit 163 gives the information on the determined services to the service information providing unit 164.

The service information providing unit 164 transmits a list of services determined by the service narrowing-down unit 163 to the terminal device 200. The service grouping unit 165 determines which service category each service belongs to, based on the service information stored in the service information storage unit 120. Specifically, the service grouping unit 165 compares the features of a service indicated by service information with the features of the services belonging to a service category indicated by service category information stored in the service category storage unit 130, and when they partly or wholly match, the service being examined is included in the service category group. When a service is included in a service category group, the service groping unit 165 registers the identification information of the added service in the corresponding service category metadata stored in the metadata storage unit 140.

The server 300 has a content storage unit 310. The content storage unit 310 stores content to be provided to the terminal device 200.

Data previously prepared in the system of FIG. 7 will be now described in detail.

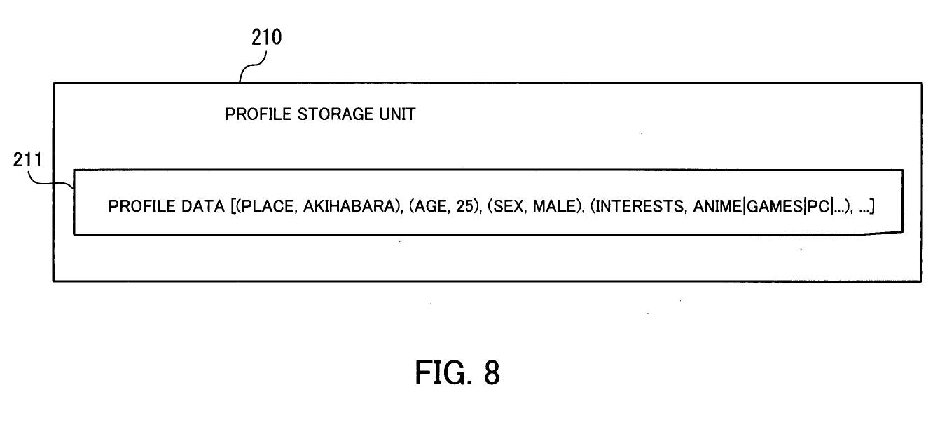

FIG. 8 shows profile data stored in the profile storage unit. The profile data 211 expresses user personal data. Specifically, the profile data 211 contains at least one piece of attribute information comprising an attribute name and attribute value(s). The attribute name represents an attribute such as “place”, “age”, “sex”, or “interests”. The attribute value is user data with respect to a corresponding attribute name. For example, a place where a user now exists is set with respect to an attribute name “place”. User's age is set with respect to an attribute name “age”.

Some attribute values may be set in one piece of attribute information. For example, some user's interests can be set as attribute values of attribute information for an attribute name “interests”.

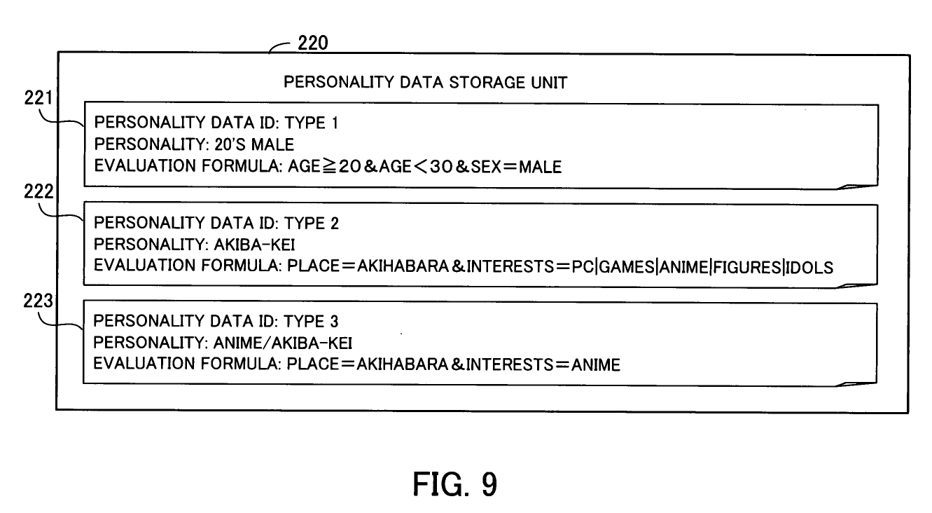

FIG. 9 shows an example of personality data stored in the personality data storage unit. Each of personality data 221, 222, and 223 contains a personality data ID, a personality, and an evaluation formula.

The personality data ID is an identifier unique to personality data. The personality is a title of the personality data. If personality data is set for 20's male, “20's male” is set as the personality.

The evaluation formula is a conditional expression to be used for specifying service categories. Age, sex, place, interests, and so on can be set in the conditional expression. For example, the personality data 221 has a logical SUM for such conditions that an age group should be 20 or over and less than 30, and sex is male.

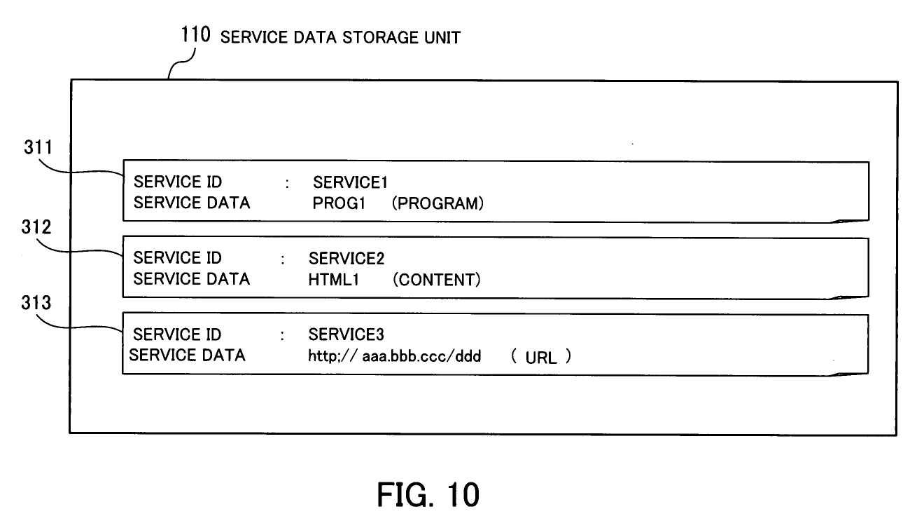

FIG. 10 shows an example of service data stored in the service data storage unit. Each of service data 311 to 313 contains a service ID and service data. The service ID is an identifier unique to a service. The service data is a program for providing the service, content, or a URL to be used for accessing content.

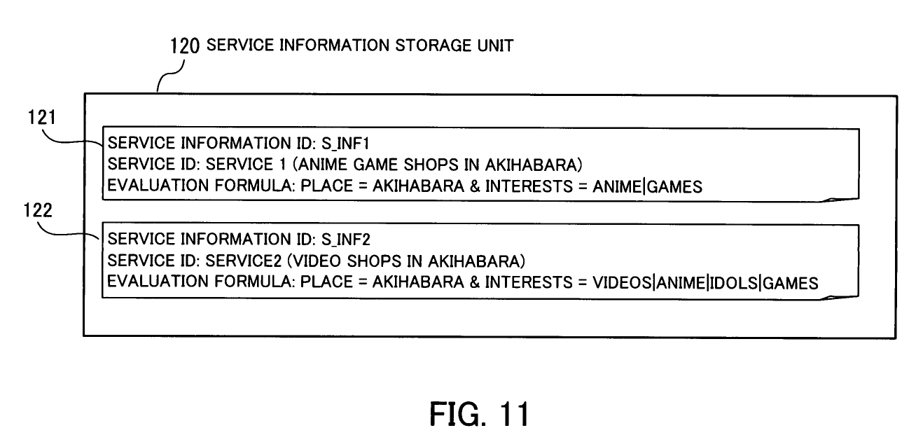

FIG. 11 shows an example of service information stored in the service information storage unit. Each of service information 121 and 122 contains a service information ID, a service ID and an evaluation formula. The service information ID is an identifier unique to service information. The service ID is an identifier (identifier of a corresponding service) showing which service this metadata is for. The evaluation formula expresses the features of the service. For example, as an evaluation formula for content introducing anime and game shops in Akihabara, “place=Akihabara & interests=animelgames” is set.

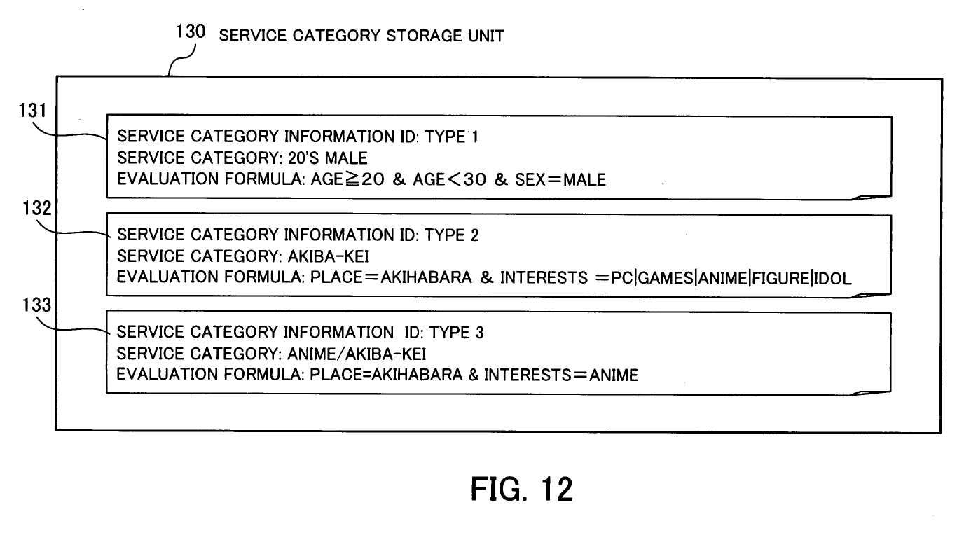

FIG. 12 shows an example of service category information stored in the service category storage unit. Each of service category information 131 to 133 contains a service category information ID, a service category, and an evaluation formula. The service category information ID is an identifier unique to service category information. The service category is a title of the service category information. As the service category, a title adequately explaining target users of the service category information is set. For example, if target users are people who like Akihabara, a service category of “Akiba-kei (a type of people who seem to like Akihabara)” is set in the service category information. As other examples of service category, 20's male, anime and Akiba-kei, couple, family, children, elderly, and so on are set. The evaluation formula is a conditional expression to be used for searching for personality data matching the service category.

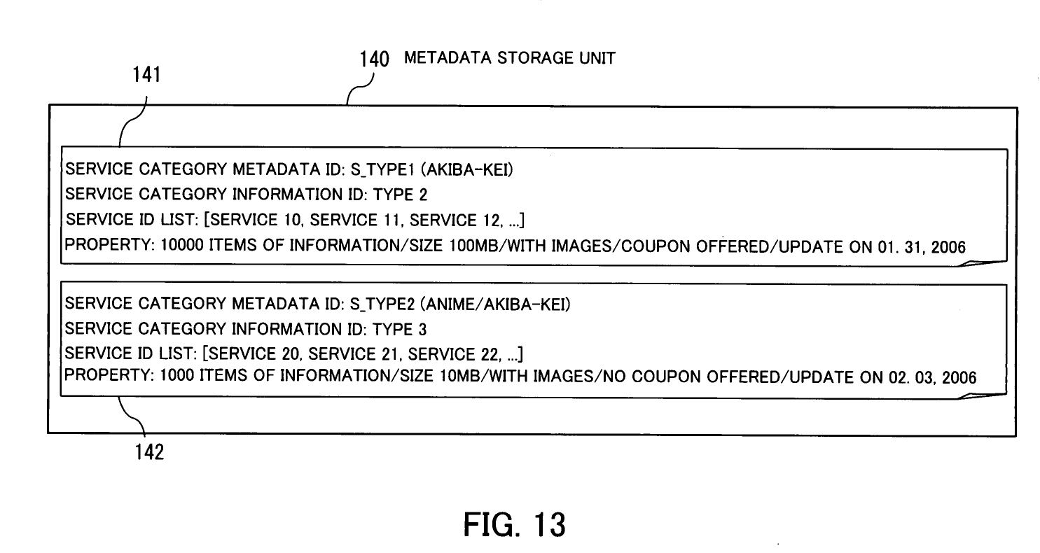

FIG. 13 shows an example of service category metadata stored in the metadata storage unit. Each of service category metadata 141 and 142 contains a service category metadata ID, a service category information ID, a service ID list and a property. The service category metadata ID is an identifier unique to service category metadata. The service category information ID is an identifier of service category information that this metadata is for. The service ID list is a list of service IDs belonging to the same service category group. The property shows the features of the services belonging to the same group. For example, the number of information, data volume (size) of entire information, existence or absence of image data, existence or absence of special offer such as coupons, and last update date and time are set as the property.

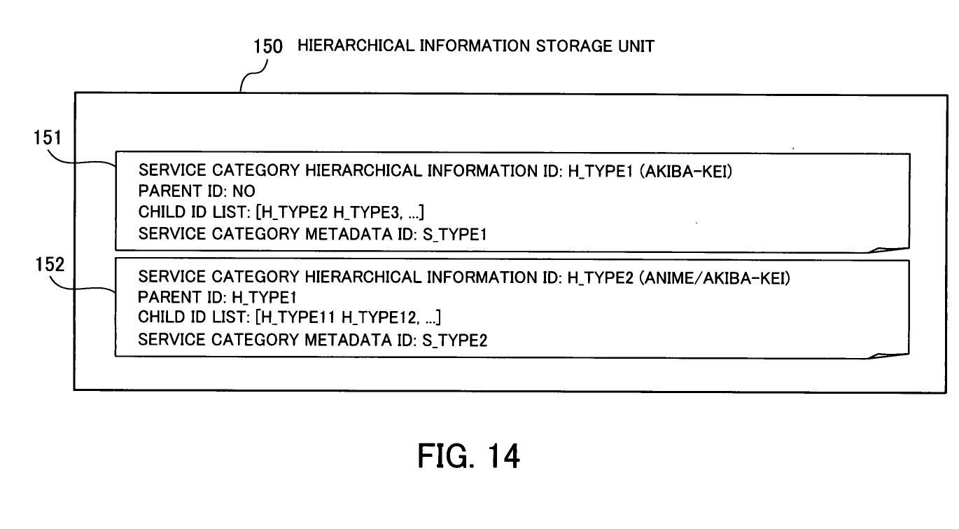

FIG. 14 shows an example of service category hierarchical information stored in the hierarchical information storage unit. Each of service category hierarchical information 151 and 152 contains a service category hierarchical information ID, a parent ID, a child ID list, and a service category metadata ID.

The service category hierarchical information ID is an identifier unique to service category hierarchical information. The parent ID is the identifier of the service category hierarchical information of one higher level (parent) in the hierarchical structure. The child ID list is a list of the identifiers of service category hierarchical information of one lower level (children) in the hierarchical structure. The service category metadata ID is the identifier of corresponding service category metadata.

The processes to be executed in the above system will be now described.

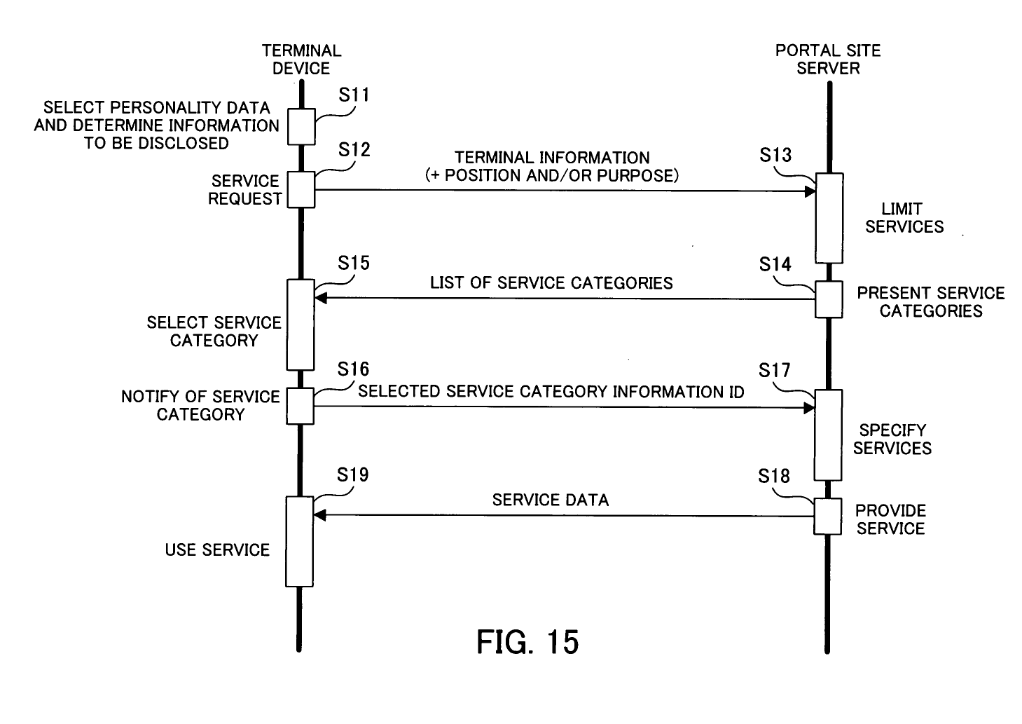

FIG. 15 shows a processing sequence between a terminal device and a portal server. The processes of FIG. 15 will be described step by step.

[Step S11] The personality data selector 230 and the disclosure determination unit 240 select personality data and determine which information is to be disclosed, according to user operation. This process is executed as follows.

The personality data selector 230 of the terminal device 200 selects at least one piece of personality data from the personality data storage unit 220 according to user operation. It can be designed so that if the user desires to use services based on his/her personal data by disclosing this data, the personality data selector 230 selects a corresponding profile in the profile storage unit 210 as personality data. The personality data selector 230 gives the selected personality data to the service request unit 250.

Next, the disclosure determination unit 240 determines which information such as a position or purposes is to be disclosed, according to user operation. If positional information is to be disclosed, the disclosure determination unit 240 obtains the latitude and longitude of the current place with a Global Positioning System (GPS) installed in the terminal device 200, detects a place name corresponding to the latitude and longitude from the base station of the terminal device 200, and sets this place name as the positional information. On the other hand, if purpose information is to be disclosed, the disclosure determination unit 240 accepts information about purposes for using services from the user and sets this information as purpose information. Then the disclosure determination unit 240 gives the information to be disclosed, to the service request unit 250.

[Step S12] The service request unit 250 issues a service request to the portal site server 100. At this time, the service request unit 250 transmits the terminal information and the information to be disclosed (position and/or purposes) to the portal site server 100. If the user does not want to disclose any information, only terminal information is to be transmitted to the portal site server 100. The terminal information includes the free memory capacity (that is expressed in a unit of megabyte or by the number of storable service data) of the memory of the terminal device 200, for example.

[Step S13] The service limiting unit 161 of the portal site server 100 limits service category information based on the terminal information and disclosed positional information or the like, transmitted together with the service request from the terminal device 200.

Specifically, if the positional information is disclosed from the terminal device 200, the service limiting unit 161 obtains from the service category storage unit 130 service category information having an evaluation formula that includes the place specified by the positional information as a place attribute. If purpose information specifying “gourmets” is disclosed from the terminal device 200, the service limiting unit 161 obtains from the service category storage unit 130 service category information containing information on menus of restaurants or the like.

If the terminal device 200 transmits only terminal information together with the service request, the service limiting unit 161 obtains all service category information from the service category storage unit 130.

Then, the service limiting unit 161 limits the obtained service category information based on the terminal information. Specifically, the service limiting unit 161 first selects the highest-level service category information in the hierarchical structure. Next, the service limiting unit 161 replaces service category information of data volume larger than the free memory capacity of the terminal device 200, out of the selected service category information, with service category information of lower level.

Note that the hierarchical structure among the service category information is determined based on the service category hierarchical information stored in the hierarchical information storage unit 150. In addition, the data volume of service category information is detected from the service category metadata stored in the metadata storage unit 140.

If there is service category information of data volume larger than the free memory capacity of the terminal device 200 out of the lower-level service category information, the service limiting unit 161 replaces the service category information with service category information of further lower level.

In this way, the service category information is sequentially limited until data volume (size) is smaller than the free memory capacity of the terminal device 200. Then the service limiting unit 161 gives the set of service category information resulted from the limiting to the service category presenter 162.

[Step S14] The service category presenter 162 transmits the set of service category information given from the service limiting unit 161 to the terminal device 200.

[Step S15] The service category selector 260 of the terminal device 200 selects service category information matching the personality data given from the personality data selector 230, out of the set of service category information given from the portal site server 100. For example, the service category selector 260 compares identical attributes of the evaluation formula between the personality data and the service category information to find whether they match. For example, attributes such as age and sex are compared individually.

With respect to the attribute comparison, if attribute values of both sides match even partially, they are identified as match. For example, in a case of comparing an attribute of age, if the age group set in the personality data and the age group set in the service category information have identical ages, then they are identified as match. Similarly, with respect to an attribute of interests, if the personality data and the service category information have at least one same interest, this comparison results in match.

Attribute information to be compared should be included both in personality data and in service category information. Attribute information that is included in only one of the personality data and the service category information is excluded from the comparison in the service category selection process.

When a plurality of attribute information of service category information is compared, the service category information is selected only when the plurality of attribute information is all identified as match (logical product). Alternatively when a plurality of attribute information of service category in formation is compared, the service category information may be selected when at least one piece of attribute in formation is identified as match (logical sum). In this connection, the user can desirably switch between logical product and logical sum.

The service category selector 260 gives the selected service category information to the service category notification unit 270.

[Step S16] The service category notification unit 270 transmits the identifier (service category information ID) of the service category information given from the service category selector 260 to the portal site server 100.

[Step S17] The service narrowing-down unit 163 of the portal site server 100 obtains the service category metadata of the corresponding service category information from the metadata storage unit 140 based on the service category information ID given from the terminal device 200. The service narrowing-down unit 163 obtains the service ID list from the obtained service category metadata. The service narrowing-down unit 163 gives the obtained service ID list to the service information providing unit 164.

[Step S18] The service information providing unit 164 obtains the service data corresponding to the service IDs included in the service ID list given from the service narrowing-down unit 163, from the service data storage unit 110. Then the service information providing unit 164 transmits the obtained service data to the terminal device 200.

[Step S19] The service use unit 280 of the terminal device 200 selects certain service data from the service data received from the portal site server 100 according to user operation, and uses the service. For example, if the selected service data is a program, this program is executed. If the selected service data is HTML content, the content of the HTML document is displayed on a screen. If the selected service data is a URL of data stored on another server (server 300, for example), the content corresponding to the URL is obtained from the content storage unit 310 of the server 300 and is displayed.

As described above, appropriate services are provided depending on user-selected personality data and positional information or the like disclosed by the user.

Next explanation is about how to limit service category information.

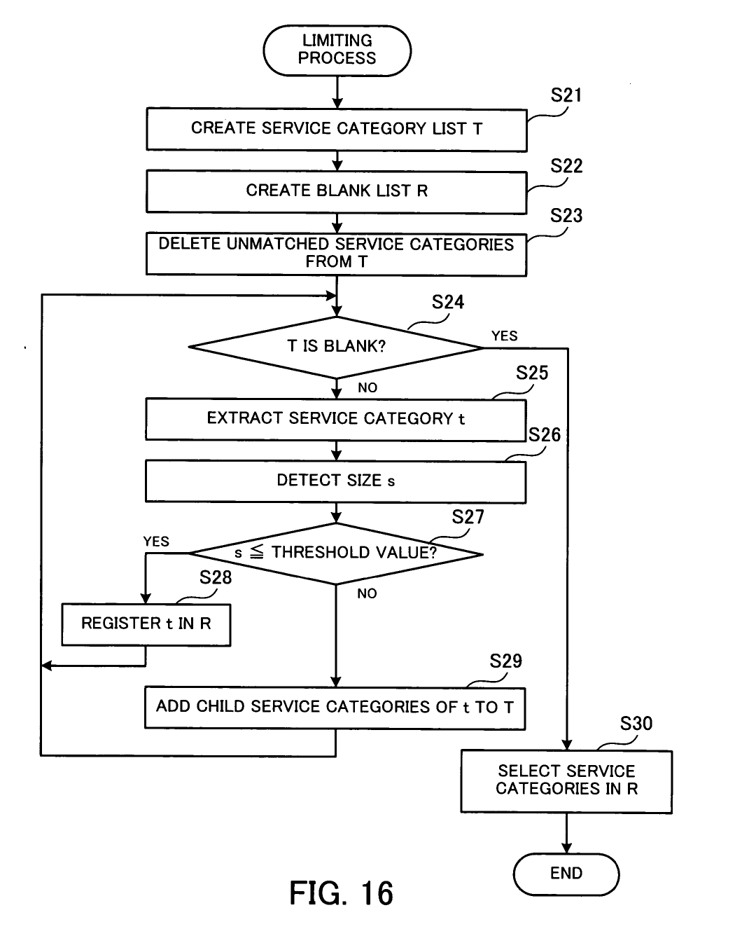

FIG. 16 is a flowchart showing the limiting process of service category information. This flowchart of FIG. 16 will be described step by step.

[Step S21] The service limiting unit 161 creates a list T of service category information which is a root of the hierarchical structure of service categories.

[Step S22] The service limiting unit 161 creates a blank list R. The list R is used as a list of service category information to be presented.

[Step S23] If there is information (position or purposes) disclosed by the user, the service limiting unit 161 compares the evaluation formula of this information with the evaluation formula of the service category information. Then the service limiting unit 161 excludes from the list T the service category information having evaluation formulae that do not match the disclosed information.

[Step S24] The service limiting unit 161 determines whether the list T has no data. When no data exists, the process goes on to step S30. If service category information remains in the list T, this process goes on to step S25.

[Step S25] The service limiting unit 161 extracts one piece of service category information t from the list T. The extracted service category information t is deleted from the list T.

[Step S26] The service limiting unit 161 detects the size s (data volume) of the extracted service category information by referring to the metadata storage unit 140.

[Step S27] The service limiting unit 161 determines whether the size s is equal to or smaller than a threshold value. The threshold value indicates the free memory capacity of the memory of the terminal device set in the terminal information. If the size s is equal to or smaller than the threshold value, the process goes on to step S28. Otherwise, the process goes on to step S29.

[Step S28] The service limiting unit 161 adds the service category information t to the list R. Then the process goes back to step S24.

[Step S29] The service limiting unit 161 registers all child service category information of the service category information t in the list T by referring to the hierarchical information storage unit 150. Thereby the service category information t is limited. Then the process goes back to step S24.

[Step S30] When the list T has no data (Yes in step S24), the service limiting unit 161 extracts a set of service category information included in the list R, and gives it to the service category presenter 162.

As described above, the service categories are limited.

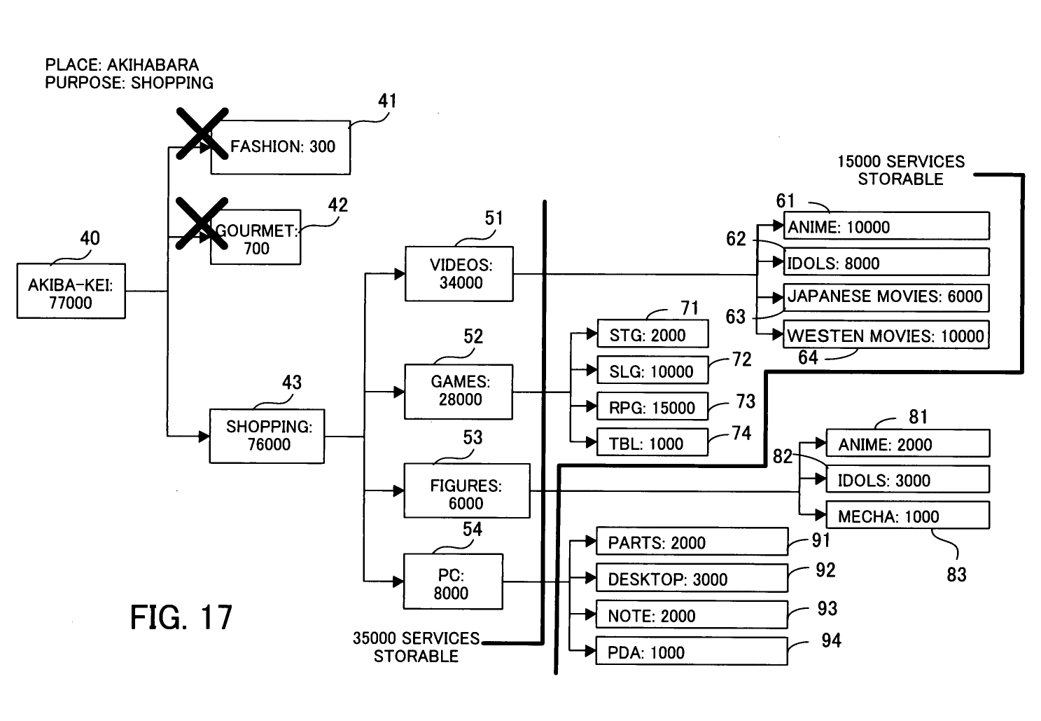

FIG. 17 shows an example of how to limit and provide service data based on purposes. Service categories that can be provided based on the free memory capacity of the terminal device are determined based on the number of services included in the service categories.

This figure shows lower-level service categories of a service category “Akiba-kei” 40. The service category “Akiba-kei” 40 contains 77000 services. As lower-level service categories (children) of the service category “Akiba-kei” 40, service categories 41 to 43 of “fashion”, “gourmets”, and “shopping” exist. The service category “fashion” 41 contains 300 services, the service category “gourmets” 42 contains 700 services, and the service category “shopping” 43 contains 76000 services.

The service categories 51 to 54 of “videos”, “games”, “figures”, and “PC” exist in the lower-level (children) of the service category “shopping” 43. The service category “videos” 51 contains 34000 services, the service category “games” 52 contains 28000 services, the service category “figures” 53 contains 6000 services, and the service category “PC” 54 contains 8000 services.

As the lower level (children) of the service category “videos” 51, service categories 61 to 64 of “anime”, “idols”, “Japanese movies”, “Western movies” exist. The service category “anime” 61 contains 10000 services, the service category “idols” 62 contains 8000 services, the service category “Japanese movies” 63 contains 6000 services, and the service category “Western movies” 64 contains 10000 services.

As the lower-level (children) of the service category “games” 52, service categories 71 to 74 of “STG”, “SLG”, “RPG”, and “TBL” exist. The service category “STG” 71 contains 2000 services, the service category “SLG” 72 contains 10000 services, the service category “RPG” 73 contains 15000 services, and the service category “TBL” 74 contains 1000 services.

As the lower level (children) of the service category “figures” 53, service categories 81 to 83 of “anime”, “idols”, and “mecha” exist. The service category “anime” 81 contains 2000 services, the service category “idols” 82 contains 3000 services, and the service category “mecha” 83 contains 1000 services.

As the lower-level (children) of the service category “PC” 54, service categories 91 to 94 of “parts”, “desktop”, “note”, and “PDA” exist. The service category “parts” 91 contains 2000 services, the service category “desktop” 92 contains 3000 services, the service category “note” 93 contains 2000 services, and the service category “PDA” 94 contains 1000 services.

Now, it is assumed that a service request issued from the terminal device to the portal site server 100 discloses “Akihabara” and “shopping” as positional information and purpose information. The limiting process will be described in view of two cases: one is that the free memory capacity of the terminal device indicated by the terminal information can store up to 35000 services and the other is up to 15000 services.

Since “Akihabara” is disclosed as positional information, the service limiting unit 161 first selects the lower-level service categories 41 to 43 of the service category “Akiba-kei” 40 (registers the corresponding service category information in a list T). Then since the purpose is “shopping”, the service limiting unit 161 excludes the service categories “fashion” and “gourmets” 41 and 42 (removes the corresponding service category information from the list T) out of the child service categories 41 to 43 of the service category “Akiba-kei” 40.

Then the service limiting unit 161 limits the service category “shopping” 43 based on the free memory capacity of the terminal device 200. In a case where the free memory capacity can store up to 35000 services, it is recognized that the service category “shopping” 43 contains too many services. Therefore, the service category “shopping” 43 is limited to the four service categories 51 to 54 (the corresponding service category information is registered in the list T). Since each of the service categories 51 to 54 contains 35000 services or less, the service categories “videos”, “games”, “figures”, and “PC” 51 to 54 are registered in the list R and are presented.

In a case where the free memory capacity of the terminal device 200 can store up to 15000 services, on the other hand, the service category “videos” 51 and the service category “games” 52 exceed the number of services storable in the free memory capacity of the terminal device. Therefore, the two service categories 51 and 52 are limited. The service category “videos” 51 is limited to the four service categories 61 to 64 of “anime”, “idols”, “Japanese movies”, and “Western movies”. In addition, the service category “games” 52 is limited to the four service categories 71 to 74 of “STG”, “SLG”, “RPG”, and “TBL”. Since each service category 61 to 64 and 71 to 74 has 15000 services or less, they can be stored on the memory of the terminal device 200.

As described above, the service categories selected based on purposes can be limited based on the terminal information (such as free memory capacity of the terminal device 200). Then the terminal device 200 automatically selects a service category matching personality data out of the obtained service categories. The service categories presented by the portal site server 100 contain only services that can be stored in the free memory capacity of the terminal device 200, so that if any one of the service categories is selected, the service information on the services included in the selected service category can be stored on the terminal device 200.

Now, an example of providing service information in this embodiment will be described.

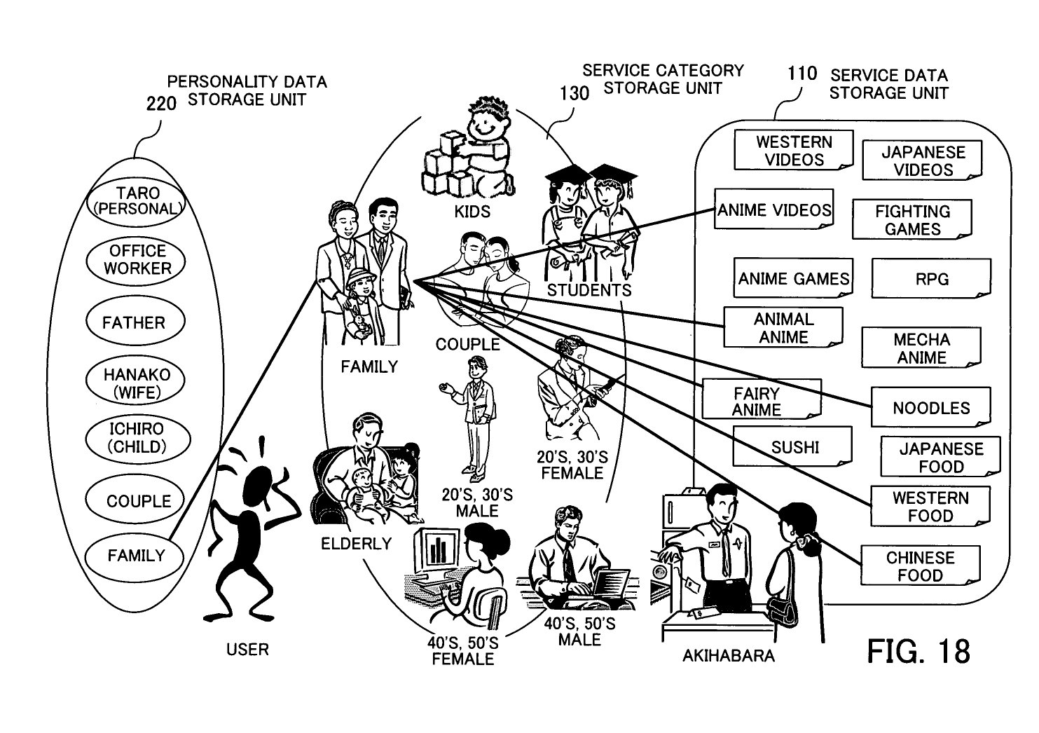

FIG. 18 shows a first example of providing service data based on selected personality data. This example shows a case where the user selects personality data of “family” out of a plurality of personality data stored in the personality data storage unit 220, and discloses a place of “Akihabara”.

The portal site server 100 provides the terminal device 200 with service category information relating to “Akihabara” out of the service category information stored in the service category storage unit 130. The terminal device 200 selects the service category information of “family” matching the personality data of “family”, out of the plurality of service category information obtained from the portal site server 100. In this example, the service category information of “family” is associated with service data of “anime videos”, “animal anime”, “fairy anime”, “noodles”, “Western food”, and “Chinese food”, out of a plurality of service data including a place attribute of “Akihabara”. Then the portal site server 100 transmits the service data associated with the service category information of “family” to the terminal device 200.

In this connection, the services can be further narrowed down according to purposes of using services. For example, if too many services appear by disclosing only the place of “Akihabara”, the service data can be further narrowed down by disclosing the purposes of using services.

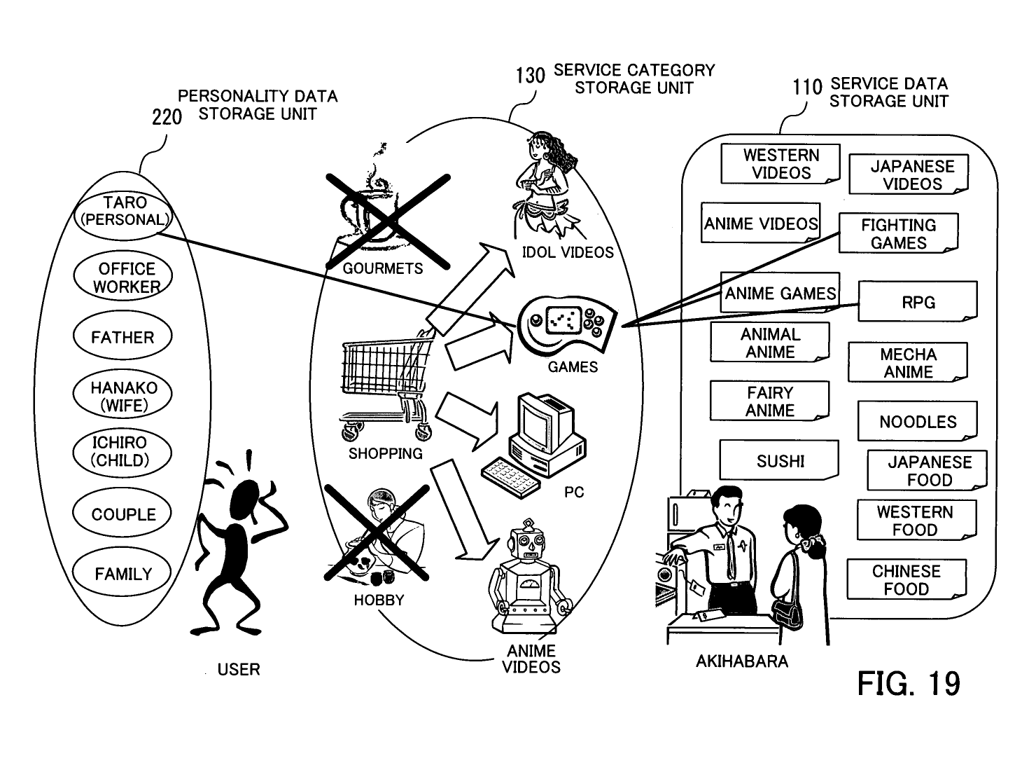

FIG. 19 shows a second embodiment of providing service data based on selected personality data. This example shows a case where the user selects personality data of “Taro (personal)” and discloses a place of “Akihabara” and a purpose of “shopping”.

The portal site server 100 provides the terminal device 200 with service category information relating to “shopping” having a place attribute of “Akihabara”, out of the service category information stored in the service category storage unit 130. That is, the service category information relating to “gourmets”, and “hobby” other than “shopping” is excluded from being provided even the information shows the place attribute of “Akihabara”. Since it is recognized that the service category information of “shopping” has too may services, this information is limited into service category information of “idol videos”, “games”, “personal computers”, and “anime videos”. As a result, a plurality of service category information obtained by limiting the service category information indicating “shopping” at “Akihabara” is provided.

The terminal device 200 selects service category information of “games” matching the personality data “Taro (personal)” out of the plurality of service category information obtained from the portal site server 100. In this example, the service category information of “games” is associated with the service data of “fighting games”, “anime games” and “RPG” out of the service data having the place attribute of “Akihabara”. Then the portal site server 100 transmits the service data associated with the service category information of “games” to the terminal device 200.

As described above, in accordance with this embodiment, services can be personalized (service data can be obtained) via service category information with less personal data disclosed. That is, the server presents categories appropriately limited according to user situations, and the terminal device specifies the most appropriate category out of the presented categories. Thereby the terminal can obtain only necessary services from the server simply. In addition, the portal site server 100 presents only categories appropriately limited based on user situations (positional information and purpose information) and resource limit (free memory capacity). Therefore, unnecessary categories can be excluded, resulting in reducing the number of categories to be presented. The user can specify a service by using personalities (typical user types), which can prevent personal data from being disclosed to the server unnecessarily.

The processing functions described above can be realized by a general computer. In this case, a program is prepared, which describes processes for the functions to be performed by the portal site server 100 and the terminal device 200. The program is executed by a computer, whereupon the aforementioned processing functions are accomplished by the computer. The program describing the required processes may be recorded on a computer-readable recording medium. Computer-readable recording media include magnetic recording devices, optical discs, magneto-optical recording media, semiconductor memories, etc. The magnetic recording devices include Hard Disk Drives (HDD), Flexible Disks (FD), magnetic tapes, etc. The optical discs include Digital Versatile Discs (DVD), DVD-Random Access Memories (DVD-RAM), Compact Disc Read-Only Memories (CD-ROM), CD-R (Recordable)/RW (ReWritable), etc. The magneto-optical recording media include Magneto-Optical disks (MO) etc.

To distribute the program, portable recording media, such as DVDs and CD-ROMs, on which the program is recorded may be put on sale. Alternatively, the program may be stored in the storage device of a server computer and may be transferred from the server computer to other computers through a network.

A computer which is to execute the program stores in its storage device the program recorded on a portable recording medium or transferred from the server computer, for example. Then, the computer runs the program. The computer may run the program directly from the portable recording medium. Also, while receiving the program being transferred from the server computer, the computer may sequentially run this program.

According to this invention, a server presents a plurality of service category information to a terminal device, and provides the terminal device with services corresponding to service category information selected by the terminal device. Therefore, the user can obtain service data appropriate for his/her personal data by using the terminal device without disclosing the personal data to the server.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A service providing method for providing services via a network, wherein:
service category presentation means, when receiving a service request from a terminal device connected over the network, extracts and transmits a plurality of service category information from service category storage means to the terminal device, the service category storage means storing the service category information indicating features of groups into which available services are classified;
service specifying means, when receiving identification information of selected service category information from the terminal device, specifies services associated with the selected service category information by referring to metadata storage means storing service category metadata of services associated with each of the service category information stored in the service category storage means; and
service providing means extracts and transmits service data on the services specified from service data storage means to the terminal device, the service data storage means storing the service data necessary for provision of the services.

2. The service providing method according to claim 1, wherein:
the metadata storage means stores data volume information indicating a total volume of the service data necessary for the provision of the services associated with each of the service category information;
if information indicating a free memory capacity of the terminal device is added to the service request, service category limiting means specifies large-volume service category information associated with services having a data volume that exceeds the free memory capacity by referring to the metadata storage unit, and limits, by referring to hierarchical information storage means, the large-volume service category information by replacing the large-volume service category information with a plurality of lower-level service category information in a hierarchical structure, the hierarchical information storage means storing service category hierarchical information indicating the hierarchical structure of the service category information; and
the service category presentation means transmits to the terminal device the plurality of lower-level service category information resulted from limiting of the service category limiting means with respect to the large-volume service category information associated with the services having the data volume that exceeds the free memory capacity.

3. The service providing method according to claim 1, wherein:
the service category information stored in the service category storage means includes attribute information indicating a place as information indicating features of the services associated with the service category information; and
when positional information indicating a position where the terminal device exists is added to the service request, the service category presentation means extracts and transmits the service category information that includes a place attribute matching the position indicated by the positional information, from the service category storage means to the terminal device.

4. The service providing method according to claim 1, wherein:
the service category information stored in the service category storage means includes attribute information indicating a purpose of use as information indicating features of the services associated with the service category information; and
when purpose information indicating a purpose of using the services is added to the service request, the service category presentation means extracts and transmits the service category information that includes a purpose attribute matching the purpose of use indicated by the purpose information, from the service category storage means to the terminal device.

5. A computer-readable recording medium containing a service providing program for providing services via a network, the service providing program causing a computer to perform as:
service category storage means for storing service category information indicating features of groups into which available services are classified;
metadata storage means for storing service category metadata of services associated with each of the service category information stored in the service category storage means;
service data storage means for storing service data necessary for provision of the available services;
service category presentation means for, when receiving a service request from a terminal device connected over the network, extracting and transmitting a plurality of service category information from the service category storage means to the terminal device;
service specifying means for, when receiving identification information of selected service category information from the terminal device, specifying services associated with the selected service category information by referring to the metadata storage means; and
service providing means for extracting and transmitting service data on the services specified from the service data storage means to the terminal device.

6. A service providing apparatus for providing services via a network, comprising:
service category storage means for storing service category information indicating features of groups into which available services are classified;
metadata storage means for storing service category metadata of services associated with each of the service category information stored in the service category storage means;
service data storage means for storing service data necessary for provision of the available services;
service category presentation means for, when receiving a service request from a terminal device connected over the network, extracting and transmitting a plurality of service category information from the service category storage means to the terminal device;
service specifying means for, when receiving identification information of selected service category information from the terminal device, specifying services associated with the selected service category information by referring to the metadata storage means; and
service providing means for extracting and transmitting service data on the services specified from the service data storage means to the terminal device.
